(19) United States
(12) Patent Application Publication
(10) Pub. No.: US 2008/0303222 A1
(43) Pub. Date: Dec. 11, 2008

(54) FACE SEAL AND METHOD OF MAKING

(75) Inventor: John W. Kosty, Fountain Valley, CA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/135,752

(22) Filed: Jun. 9, 2008

Related U.S. Application Data
(60) Provisional application No. 60/942,533, filed on Jun. 7, 2007.

(51) Int. Cl. F16J 15/34; B23P 11/02

(52) U.S. Cl. 277/358; 29/450

(57) ABSTRACT

A face seal is provided that includes an annular casing having an annular portion, an inner diameter portion extending axially from the annular portion, an outer diameter portion extending axially from the annular portion, and a generally circular opening defined by the contour of an outer surface of the inner diameter portion. The face seal further includes an inner seal member disposed along an inner surface of the inner diameter portion, and an outer seal member disposed along an inner surface of the outer diameter portion.

### CROSS-REFERENCE TO RELATED APPLICATION(S)

The present application claims priority from U.S. Provisional Patent Application No. 60/942,533, filed Jun. 7, 2007, entitled “FACE SEAL AND METHOD OF MAKING”, naming inventor John W. Kosty, which application is incorporated by reference herein in its entirety.

### BACKGROUND

1. Field of the Disclosure

This application is directed to sealing devices, and particularly directed to sealing devices utilizing composite constructions including a casing.

2. Description of the Related Art

Sealing devices, such as seal rings or the like, are well known in the art for providing a seal between opposed sealing surfaces. Such sealing devices can be used to provide a tight seal between sealing surfaces that are static with respect to one another, and/or between sealing surfaces that are dynamic relative to one another, e.g., between a static and dynamic, or between two dynamic sealing surfaces. An example type of dynamic sealing application is a seal ring that is disposed between a static housing and a dynamic rotary or reciprocating sealing surfaces.

Many different types of seals are known, and are generally constructed for a particular sealing application. For example, lip seals are well known in the art, and can be constructed to include a non-flexible member and a relatively conformable nonmetallic, e.g., polymeric, seal member. The metallic seal member is typically in the form of a mounting that is configured both to fit within a predetermined seal gland, and to provide a substrate for the nonmetallic seal member. More specifically, the metallic seal member is in the form of a ring-shape that is designed to provide a predetermined amount of compression or tension to the attached nonmetallic seal member forming the lip. Generally, however, such seals are designed to seal around cylindrical or tubular surfaces. And often, such tubular surfaces are dynamic surfaces which are moving relative to the lip seal.

Face seals, sometimes referred to as o-rings, by design are intended to sit between two planar surfaces and form a seal between these surfaces. Generally, face seals incorporate simpler designs than those of lip seals as they can typically be made of a single piece of material such as a polymer. Recently, some face seals have incorporated a composite design including materials such as metals and polymers.

As the industry continues to offer machines to consumers that provide enhanced performance, such machines must continue to utilize integral components (i.e., seals) which enable enhanced performance. Accordingly, the industry continues to desire seals that are capable of providing improved performance.

### SUMMARY

According to a first aspect a face seal is provided that includes an annular casing having an annular portion, an inner diameter portion extending axially from the annular portion, an outer diameter portion extending axially from the annular portion, and a generally circular opening defined by the contour of an outer surface of the inner diameter portion. The face seal further includes an inner seal member disposed along an inner surface of the inner diameter portion, and an outer seal member disposed along an inner surface of the outer diameter portion.

According to a second aspect a face seal is provided that includes an annular casing having a base portion, an inner diameter portion, and an outer diameter portion, wherein the inner diameter portion, outer diameter portion, and base portion define an annular channel. Additionally, the inner diameter portion has a circumference less than the circumference of the outer diameter portion. The face seal further includes an inner seal member extending along at least a portion of the circumference of the inner diameter portion and extending at least partially into the channel, and an outer seal member extending along at least a portion of the circumference of the outer diameter portion and extending at least partially into the channel.

According to another aspect a method of making a face seal is provided. The method includes the steps of forming an annular casing having a base portion, an inner diameter portion, and an outer diameter portion, wherein said inner diameter portion, outer diameter portion, and base portion define an annular channel, and the inner diameter portion has a circumference less than the circumference of the outer diameter portion. The method further includes the steps of forming an inner seal member having an annular shape and forming an outer seal member having an annular shape, and combining the annular casing, inner seal member, and outer seal member to form a face seal. The formed face seal includes the inner seal member extending along at least a portion of the circumference of the inner diameter portion of the casing and extending at least partially into the channel, and the outer seal member extending along at least a portion of the circumference of the outer diameter portion of the casing and extending at least partially into the channel.

### BRIEF DESCRIPTION OF THE DRAWINGS

The present disclosure may be better understood, and its numerous features and advantages made apparent to those skilled in the art by referencing the accompanying drawings.

FIG. 1 is a flow chart illustrating a method of forming a face seal according to one embodiment.

FIG. 2A is a cross-sectional illustration of a face seal according to one embodiment.

FIG. 2B is a cross-sectional illustration of a face seal according to one embodiment.

FIG. 3 is a cross-sectional illustration of a portion of a face seal according to one embodiment.

FIG. 4 is a cross-sectional illustration of a portion of a face seal according to one embodiment.

FIG. 5 is a cross-sectional illustration of a portion of a face seal according to one embodiment.

FIG. 6 is a cross-sectional illustration of a portion of a face seal according to one embodiment.

FIG. 7 is a cross sectional diagram of a scroll compressor and a face seal according to one embodiment.

The use of the same reference symbols in different drawings indicates similar or identical items.

### DESCRIPTION OF THE EMBODIMENT(S)

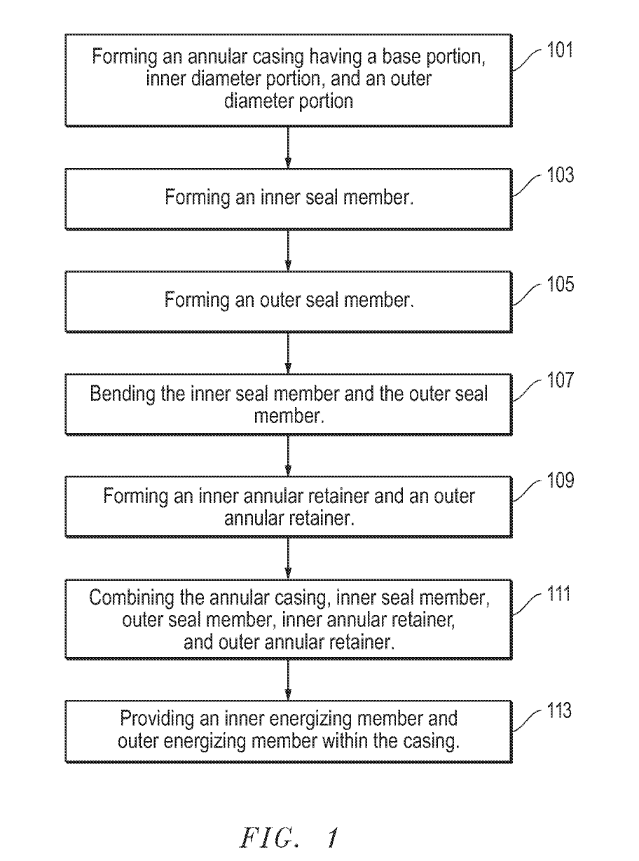

Referring to FIG. 1 a flow chart is illustrated which provides a method for forming a face seal according to one particular embodiment. At step 101, formation of the face seal is initiated by forming an annular casing having a base portion (or bottom), an inner diameter portion, and an outer diameter portion. Generally, the forming process can include a cutting process, such as cutting a piece of material from a larger piece of stock material. According to a particular embodiment, a flat annular-shaped piece of material can be cut from a larger piece of material.

Formation of the annular-shaped casing can further include a stamping process after cutting of the annular-shaped material. As such, a stamping process may use a punch and die. According to a particular embodiment, the cut piece of material is stamped to form a casing having a substantially U-shaped cross-sectional contour. Accordingly, formation of a casing having a U-shaped cross-sectional contour defines the base portion (i.e., the bottom surface), an inner diameter portion, and an outer diameter portion. Specifically, the inner diameter portion and the outer diameter portion form the portions of the U-shaped casing which extend in a direction non-parallel, or otherwise an axial direction, to the plane of the base portion. Particularly, the inner diameter portion and the outer diameter portion can extend in an axial direction that is substantially perpendicular to the plane of the base portion and define an annular channel therebetween.

Notably, the inner diameter portion and the outer diameter portions have different dimensions. As will be provided in more detail below, the inner diameter portion is generally the portion of the face seal defining the opening in the annular shape. As such, the inner diameter portion has a smaller circumference and accordingly a smaller diameter than that of the outer diameter portion.

The annular-shaped casing may undergo further processing, in which the inner diameter portion and the outer diameter portion of the casing undergo a flanging step. The flanging process can include forming flanges on the ends of the inner diameter portion and outer diameter portion, such that the ends of the inner diameter portion and the outer diameter portion are bent, typically inwards. According to one embodiment, the flanges generally extend through the entire circumference of the inner diameter portion and the outer diameter portion.

Moreover, formation of the casing can further include forming a raised portion in the base portion. Generally, such a raised portion can be formed during the initial stamping process which forms the contour of the annular-shaped casing. Alternatively, the formation of a raised portion may be undertaken as a separate stamping process. The raised portion can extend annularly along at least a portion of the base portion. In one particular embodiment, the raised portion extends annularly through the entire circumference of the base portion. Such a raised portion will be better understood in further illustrations provided herein.

In reference to the material of the annular casing, generally the annular casing includes an inorganic material. According to one embodiment, the annular casing can include a metal-containing material, such as a metal or metal alloy. Generally suitable metals may include transition metals. Particularly suitable metals can include aluminum, iron, copper, chromium, titanium, nickel, and combinations and alloys thereof.

Generally, the annular casing includes not less than about 50 wt % of a metal-containing material. According to a particular embodiment, the annular casing includes not less than about 75 wt % metal, or even 95 wt % metal. In one particular embodiment, the casing is made entirely of metal or metal alloy.

The annular casing may also include a plating material overlying one or more surfaces including the inner and outer surfaces of the base portion, inner diameter portion, and the outer diameter portion. Suitable plating materials are typically inorganic materials, and may include a metal-containing material, such as a metal or metal alloy. Generally suitable metals can include transition metals. Particularly suitable metals for the plating material can include nickel, palladium, or tin, or combinations and alloys thereof.

Referring again to FIG. 1, after forming the annular casing at step 101, the method further provides a step 103 of forming an inner seal member. Generally, the inner seal member is an annular-shaped piece of material, configured to interface with the inner diameter portion. Generally, the inner seal member can be formed via a cutting process, and particularly a process in which an annular-shaped piece of material is cut from a larger piece of stock material.

After forming the inner seal member at step 103, the method further provides a step 105 of forming an outer seal member. The formation of the outer seal member can generally include a cutting process in which an annular-shaped piece of material is cut from a larger strip of material. The outer seal member has a larger circumference than that of the inner seal member, such that it is configured to interface with the outer diameter portion.

Typically, the inner seal member and the outer seal member include the same material, which is generally an organic material, such as a polymer material. Generally suitable polymer materials include polymers containing halogen elements. Particularly suitable polymers include fluorine, that is fluorinated polymers, such as fluorocarbons. More particularly, the seal members can include perfluoroalkoxy polymer, ethylene tetrafluoroethylene, polyvinyl fluoride, polyvinylidene fluoride, fluorinated ethylene-propylene, or polytetrafluoroethylene (PTFE).

Generally, the seal members include not less than about 50 wt % of a polymer, such as not less than about 75 wt % polymer, and in some cases not less than about 90 wt % polymer. According to other embodiments, the seal members include not less than about 50 wt % of a fluoropolymer, such as not less than about 75 wt % fluoropolymer, and in some cases not less than about 90 wt % fluoropolymer. In one particular embodiment, the seal members is made entirely of PTFE.

Additionally, the seal members can be composite, including a polymer laminate layer overlying a rigid substrate. The polymer laminate layer can include those materials described above. Generally, the rigid substrate includes an inorganic material. Suitable inorganic materials can include metal-containing materials, such as a metal or metal alloy. Generally suitable metals can include transition metals. Particularly suitable metals can include metals such as aluminum, iron, copper, chromium, titanium, nickel, and alloys thereof. According to a particular embodiment, the inner seal member is a composite material having at least one polymer laminate layer including PTFE overlying a substrate including aluminum.

After forming the outer seal member at step 105, the method provides a step 107 of bending the inner seal member and the outer seal member. During the bending process, the inner seal member and the outer seal member are formed such that a bend is formed in each of the seal members. The bend generally extends through a circumference of the seal member between the inner and outer circumference such that there is an annular portion that is bent in relation to another annular portion. The bending process can include a stamping process in which a portion of the annular-shaped seal is held in one plane and another portion of the annular-shaped seal member is stamped or bent into another plane. Particularly, the bending process does not cause substantial twisting or warping of the seal members, such that the annular-shape is maintained.

Referring again to FIG. 1, after bending the inner seal member and the outer seal member at step 107, the method further provides a step 109 of forming an inner annular retainer and an outer annular retainer. Forming the retainers can include a cutting process, such that each of the retainers is cut from a larger piece of material. Notably, the inner annular retainer and outer annular retainer are annular-shaped, but the outer annular retainer has a greater circumference than the inner annular retainer.

The inner annular retainer is formed such that it can be configured to interface along at least a portion of the inner diameter portion of the casing. Generally, the inner annular retainer is disposed adjacent to and extending along at least a portion of the inner diameter portion and the inner seal member. In particular, the inner annular retainer is in direct contact with and extending along at least a portion of the circumference of an inner surface of the inner diameter portion and the inner seal member. The outer annular retainer is formed such that it can be configured to interface along at least a portion of the outer diameter portion. Generally, the outer annular retainer is disposed adjacent to at least a portion of an inner surface of the outer diameter portion and the outer seal member. Particularly, the outer annular retainer is in direct contact with and extending along at least a portion of the circumference of the inner surface of the outer diameter portion and the outer seal member.

Generally, the inner annular retainer and the outer annular retainer include an inorganic material. According to one embodiment, the annular retainers can include a metal-containing material, such as a metal or metal alloy. Suitable metals may include transition metals. Particularly suitable metals can include aluminum, iron, copper, chromium, titanium, nickel, and combinations and alloys thereof. According to one embodiment, the retainers typically contain not less than about 50 wt % metal, such as not less than about 75 wt % metal, or even 95 wt % metal. In one particular embodiment, the annular retainers are made entirely of metal, and more particularly are made entirely of aluminum.

After forming the inner annular retainer and outer annular retainer, the method provides a step 111 of combining the annular casing, the inner seal member, the outer seal member, the inner annular retainer, and outer annular retainer to form a face seal. Generally, the combining process includes a pressing process, and particularly includes simultaneously pressing all of the components together to form a face seal. As such, the components can all be placed in proper position relative to one another, at which time a machine can be used to apply pressure to each of the components and form the face seal. The pressing process generally utilizes a pressure of not less than about 20 psi, such as not less than about 50 psi, and even, not less than about 200 psi. Generally, the pressing process utilizes a pressure of not less than about 2000 psi.

Additionally, the pressing process is generally carried out at lower temperatures. As such, pressing is generally carried out at a temperature of not greater than about 100° C. In one particular embodiment, the pressing temperature is not greater than about 75° C., such as not greater than about 50° C., or even not greater than about 30° C. According to a particular embodiment, the pressing process is completed at room temperature (25° C.).

Generally, the pressing process does not necessitate the use of a binder or adhesive material, however, some embodiments include the addition of chemical compositions such as adhesives or binding agents to facilitate combining the components. According to a particular embodiment, the pressing process is completed with the addition of binders, adhesives, or the like. Suitable binders or adhesives include inorganic or organic compositions, which includes synthetic or natural materials. Particularly suitable compositions include materials such as gum, resin, glue, cement, natural rubber, polychloroprene, elastomers, thermoplastics and thermosets, such as epoxy.

After combining the components in step 111, the method further provides a step 113 of providing an inner energizing member and an outer energizing member within the annular casing. The energizing members can include a spring, patterned rigid material, or other components having a resilience against permanent deformation. Generally however, the process of providing an inner energizing member and an outer energizing member includes providing an inner spring and an outer spring within the casing. Patterned rigid material type energizing members are typically integrated within the seal members as a patterned rigid substrate. For example, composite seal members including a patterned rigid substrate and an overlying polymer laminate layer. Still, embodiments can utilize more than one energizing member, such that the face seal can incorporate a patterned rigid material and a spring, or any other combination of components having a resilience against permanent deformation.

In further reference to the process of providing an inner spring and an outer spring within the annular casing, generally the inner spring is disposed adjacent to at least a portion of the inner seal member and the base portion of the annular casing. According to a particular embodiment, the inner spring is disposed in direct contact with and extending along a portion of the circumference of an inner surface of the inner seal member and the inner annular retainer, and the base portion. Generally, the outer spring is disposed adjacent to at least a portion of the outer seal member and the base portion. According to a particular embodiment, the outer spring is disposed in direct contact with a portion of an inner surface and extending along a portion of a circumference of the outer seal member, the outer annular retainer, and the base portion. Notably, the inner spring has a smaller circumference than the outer spring.

As described previously, the base portion of the casing can include a raised portion which extends annularly through a circumference of the base portion. According to such embodiments, the raised portion facilitates biasing of the inner energizing member and outer energizing member against the base portion of the casing and the inner seal member and the outer seal member.

The energizing members can typically include an inorganic material. Particularly suitable materials for the energizing members include a metal or metal alloy. Such metals can include transition metals, and particularly can include aluminum, zinc, iron, copper, cobalt, or alloys or combinations thereof.

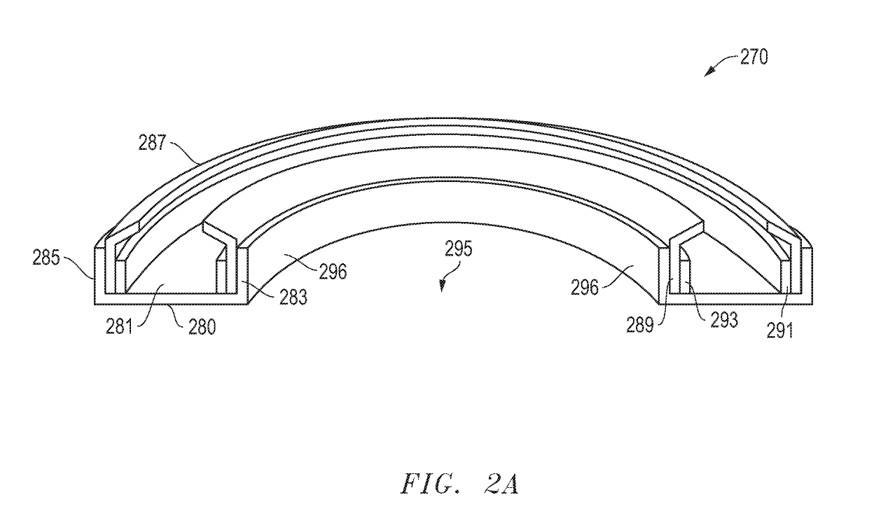

Referring to FIG. 2A, a cross-sectional diagram of a face seal 270 is illustrated according to one embodiment. Notably, FIG. 2A illustrates the general contour of a portion of a face seal according to one embodiment, and particularly the circular contour of the face seal 270. The portion of the face seal 270 includes a casing 280 which includes a base portion 281, an inner diameter portion 283, and an outer diameter portion 285. As illustrated the inner diameter portion 283 and the outer diameter portion 285 extend from the base portion 281 in an axial direction such that the inner diameter portion 283 and the outer diameter portion 285 extend at a substantially perpendicular direction from the surface of the base portion 281.

The face seal 270 further includes an opening 295, and particularly a generally circular opening defined by the outer surface 296 of the inner diameter portion 283. It will be appreciated that the contour of the outer surface 296 of the inner diameter portion 283 affects the contour of the opening 295. As such, while the opening 295 generally has a circular contour, other polygonal contours are contemplated.

The face seal 270 further includes an outer seal portion 287 and an inner seal portion 289. Moreover, the face seal 270 includes an inner annular retainer 293 and an outer annular retainer 291. The following figures will not demonstrate the perspective illustrated in FIG. 2A, and instead will simply illustrate a cross-sectional portion, but it will be appreciated that the following illustrated embodiments can include such contours, orientation, and features illustrated here in FIG. 2A.

FIG. 2B is a cross-sectional illustration of a face seal 200 according to one embodiment. As illustrated, the face seal 200 includes an annular casing 201 having a base portion 202, an inner diameter portion 203, and an outer diameter portion 205, which defines a channel 212, otherwise an opening, therebetween. As illustrated, the inner diameter portion 203 and the outer diameter portion 205 are bent in relationship to the base portion 202 such that the inner diameter portion 203 and outer diameter portion 205 extend in axial direction, out of the plane of the base portion 202. According to a particular embodiment, the inner diameter portion 203 and the outer diameter portion 205 extend in an axial direction substantially perpendicular to the plane of the base portion 202.

Moreover, the face seal 200 includes an opening 221 having boundaries defined by the outer surface 206 of the inner diameter portion 203. As illustrated, the opening 221 has dimension defined by an inner diameter (dᵢ) illustrated by the arrow 222. Typically, the inner diameter 222 is not less than about 10 mm. In one embodiment, the inner diameter 222 is greater, such as not less than about 20 mm, or not less than about 30 mm, or even not less than about 40 mm. Still, the size of the inner diameter 222 is generally not greater than about 120 mm. According to another embodiment, the inner diameter 222 is not greater than about 110 mm, such as not greater than about 100 mm, or even not greater than about 90 mm.

The face seal 200 also includes an outer diameter (dₒ) illustrated by arrow 226 which defines the greatest distant between the outer surfaces of the outer diameter portion 205. Generally, the dimension of the outer diameter 226 is not less than about 40 mm. In one particular embodiment, the outer diameter 226 is not less than about 50 mm, such as not less than about 60 mm, or even not less than about 70 mm. Still, the dimension of the outer diameter 226 is limited, such as generally not greater than about 200 mm. According to another embodiment, the outer diameter 226 is not greater than about 180 mm, or not greater than about 150 mm, or even not greater than about 130 mm.

While, the illustrated embodiment of FIG. 2B has described a face seal 200 having an opening 221 with a diameter indicating an opening with a generally circular contour, other embodiments contemplate an opening having a different polygonal contour (e.g., rectangular), and as such the dimensions provided above describe the value of the largest dimensions.

The face seal 200 includes an inner seal member 207 and an outer seal member 209. Generally, the inner seal member 207 is adjacent to at least a portion of the inner diameter portion 203. Particularly, the inner seal member 207 is in direct contact with at least a part of an inner surface of the inner diameter portion 203, and extends through at least a portion of circumference of the inner diameter portion 203.

Generally, the outer seal member 209 is adjacent to at least a portion of the outer diameter portion 205. Particularly, the outer seal member 209 is in direct contact with at least a portion of an inner surface of the outer diameter portion 205 and extends through at least a portion of the circumference of the outer diameter portion 205.

Moreover, the inner seal member 207 and outer seal member 209 are generally bent. Particularly, the inner seal member 207 and outer seal members 209 can be bent, such that portions of the seal members 207 and 208 extend in a substantially radial direction, and other portions of the seal members 207 and 208 extend in a substantially axial direction. More particularly, the seal members 207 and 208 extend from the annular casing 201 towards each other and extend at least partially into the channel 212.

According to a particular embodiment, the seal members 207 and 209 are formed to have an annular bend, which defines a seal angle. Generally, the seal angle is the angle between two portions of the same surface of a seal member that is less than about 180°. As illustrated in FIG. 2B, the inner seal member 207 is bent such that is has a seal angle 210, and the outer seal member 209 is bent such that it has a seal angle 208. In particular, the outer seal member 209 includes a first seal portion 214 and a second seal portion 215 and a seal angle 208 defined between said seal portions 214 and 215. Accordingly, the seal angle 208 is less than about 170°, and typically less than about 160°, or even less than about 150°. Still, the seal angle 208 is generally greater than about 90°, such as greater than about 110°, or greater than about 120°, and typically within a range of between about 100° and about 180°. According to a particular embodiment, the seal angles 208 and 210 are the same, and as such, the seal angles 208 and 210 have angles of less than about 170°. According to a particular embodiment, the seal angles 208 and 210 are greater than about 100°, such as greater than about 110°, and within a range of between about 120° and about 160°.

Face seal 200 further includes an inner annular retainer 211 and an outer annular retainer 213. Generally, the inner annular retainer 211 is adjacent to at least a portion of the inner seal member 207. In particular, the inner annular retainer 211 is in direct contact with at least a portion of the inner surface and extends along at least a portion of the circumference of the inner seal member 207. Generally, the outer annular retainer 213 is adjacent to at least a portion of the outer seal member 209. In particular, the outer annular retainer 213 is in direct contact with at least a portion of the inner surface and extends at least along a portion of the circumference of the outer seal member 209. Notably, the outer annular retainer 213 has a greater circumference than the inner annular retainer 211.

In addition to the features provided above, FIG. 2B illustrates a face seal 200 which has an annular casing 201 having a height “h” illustrated by the arrow 223. As illustrated, the height 223 of the annular casing 201 is measured as the distance from the bottom surface of the base portion 202 to the top surface of the inner diameter portion 203 (or outer diameter portion 205). Generally, the height 223 of the annular casing 201 is not less than about 0.5 mm. According to a particular embodiment, the height 223 is not less than about 0.75 mm, such as not less than about 1.0 mm, or even not less than about 1.5 mm. Still, the height 223 of the annular casing 201 is generally limited, such that it is not greater than about 10 mm. In one particular embodiment, the height 223 is not greater than about 9.0 mm, such as not greater than about 8.0 mm, or even not greater than about 7.0 mm.

In addition to the height 223, the face seal 200 further includes a delta “Δ” illustrated by the arrow 225 and defined herein as the distance between the top surface of the inner diameter portion 203 (or outer diameter portion 205) and the top surface of the inner seal member 207 (or outer seal member 209) while the seal is in a relaxed state. Generally, the delta 225 indicates the distance above the top surface of the casing that the seal members extend to facilitate forming a seal against a second surface. As such, the delta 225 is not less than about 0.1 mm. In one particular embodiment, the delta 225 is not less than about 0.2 mm, such as not less than about 0.3 mm, or even not less than about 0.5 mm. Still, the dimension of the delta 225 is limited, such that it is generally not greater than about 2.0 mm. According to a particular embodiment, the delta 225 is not greater than about 1.5 mm, such as not greater than about 1.25 mm, or even not greater than about 1.0 mm.

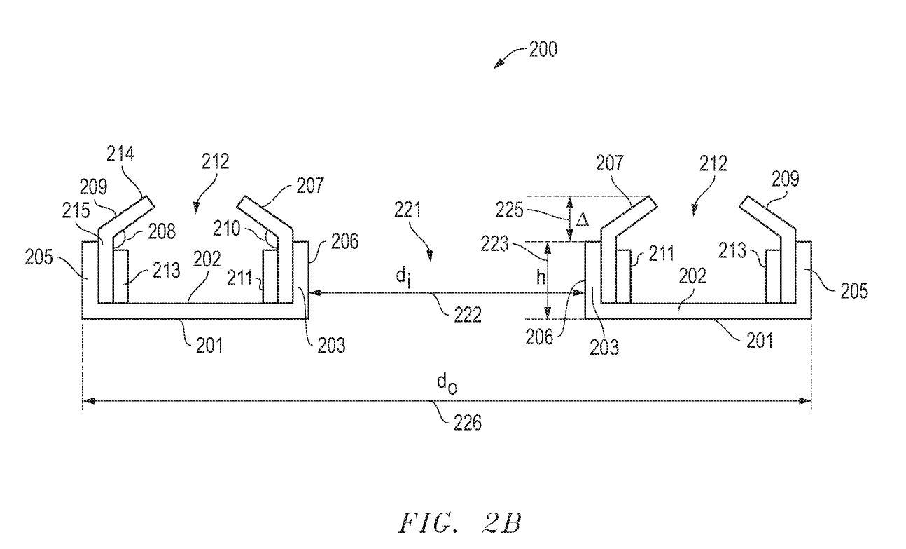

Referring to FIG. 3, a cross-sectional illustration of a portion of a face seal 300 is provided according to one embodiment. Face seal 300 includes an annular casing 301 having a base portion 302, an inner diameter portion 303, and an outer diameter portion 305. As illustrated, the inner diameter portion 303 and the outer diameter portion 305 extend in a direction substantially perpendicular to the plane of the base portion 302. The face seal 300 further includes an annular channel 312 defined between the inner diameter portion 303 and the outer diameter portion 305.

As illustrated, the inner diameter portion 303 and the outer diameter portion 305 includes flanges 304 and 306 respectively. The flanges 304 and 306 generally extend in a radial direction, particularly out of the plane defined by the inner diameter portion 303 and the outer diameter portion 305, such that said flanges 304 and 306 may extend toward each other into the annular channel 312. Particularly, the flanges 304 and 306 can be formed such that they extend in a direction substantially perpendicular to the planes defined by the inner diameter portion 303 and the outer diameter portion 305. The flanges 304 and 306 facilitate retaining the inner seal member 307 and the outer seal member 309 within the annular casing 301.

Referring again to FIG. 3 further illustrates an inner seal member 307 and an outer seal member 309. As illustrated, the inner seal member 307 and the outer seal member 309 are composite. The inner seal member 307 includes a first polymer laminate layer 341 overlying a rigid substrate 342, and a second polymer laminate layer 343 underlying the metal substrate 342. Likewise, the outer seal member 309 is a composite having a first polymer laminate layer 351 overlying a rigid substrate 352, and a second polymer laminate layer 353 underlying the metal substrate 352. As described previously, the seal members can include an organic material, and particularly the overlying and underlying polymer laminate layers 341, 343, 351, and 353 typically include a polymer. Particularly, the polymer laminate layers 341, 343, 351, and 353 include a fluoropolymer, such as PTFE. Generally, the rigid substrates 342 and 352 can include a metal containing material, such as a metal or metal alloy. Particularly, the rigid substrates 342 and 352 include a metal such as aluminum, iron, or nickel, or a combination thereof. According to a particular embodiment, the rigid substrates 342 and 352 can be a rigid patterned substrate, such that it forms an energizing member.

Referring again to FIG. 3, the inner seal member 307 includes multiple bends defining multiple seal angles 308 and 318. Seal members having multiple bends can have the same characteristics as other seal members having single bends. Accordingly, the individual seal angles of seal members having multiple bends are generally less than about 180°. According to a particular embodiment, the seal angles 308 and 318 of the inner seal member 307 are greater than about 90°, such as greater than about 100°, or even not greater than about 110°. In one embodiment, the seal angles 308 and 318 are within a range of between about 90° and about 180°, and particularly within a range of between about 110° and about 160°.

As illustrated in FIG. 3, the outer seal member 309 also has multiple bends defining multiple seal angles 314 and 324. The seal angles 314 and 324 are generally greater than about 90°. As such, in one embodiment, the seal angles 314 and 324 of the outer seal member 307 are greater than about 100°, such as greater than about 110°, or even not greater than about 120°. In one embodiment, the seal angles 314 and 324 are within a range of between about 90° and about 180°, and particularly within a range of between about 100° and about 160°.

According to another embodiment, the inner seal member 307 and the outer seal member 309 have the same number of bends defining the same number of seal angles. According to a particular embodiment, the seal angles 318 and 324 are the same, and the seal angles 308 and 314 are the same.

Face seal 300 further illustrates an inner annular retainer 311 and an outer annular retainer 313. According to one embodiment, the inner annular retainer 311 is adjacent to at least a portion of the inner surface of the inner diameter portion 303. In one particular embodiment, the inner annular retainer 311 is in direct contact with at least a portion of the inner surface and extends along at least a portion of the circumference of the inner diameter portion 303. Likewise, the outer annular retainer 313 is generally adjacent to at least a portion of the outer diameter portion 305. In one particular embodiment, the outer annular retainer 313 is in direct contact with at least a portion of the inner surface and extends along at least a portion of the circumference of the outer diameter portion 305. Utilization of the retainers 311 and 313 facilitates holding the inner seal member 307 and outer seal member 309 within the casing.

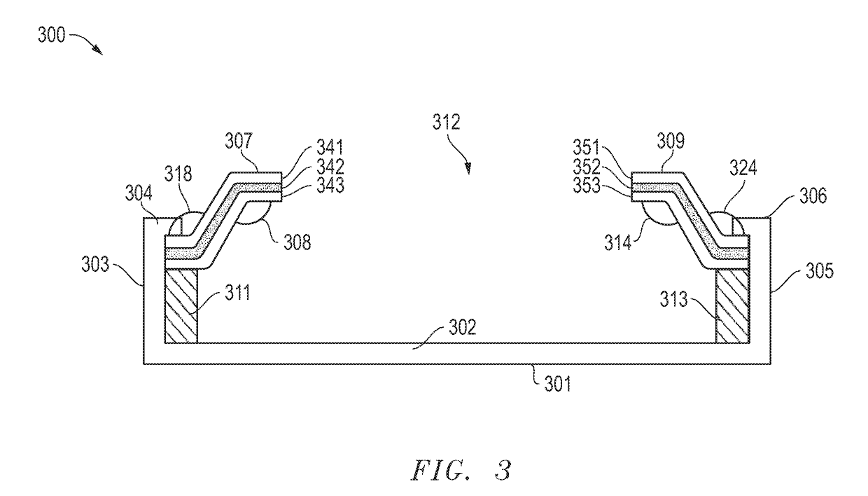

Referring to FIG. 4 a cross-sectional view of a face seal 400 according to an embodiment is illustrated. The face seal 400 includes an annular casing 401, particularly a U-shaped annular casing 401 having a base portion 402, an inner diameter portion 403, and an outer diameter portion 405, defining an annular channel 412 therebetween. The inner diameter portion 403, and an outer diameter portion 405 extend in an axial direction from the base portion 402, and particularly extend in a direction substantially perpendicular to the plane defined by the base portion 402.

The inner diameter portion 403 and the outer diameter portion 405 include flanges 404 and 406 respectively. The flanges 404 and 406 extend in a substantially radial direction, particularly in a direction out of the planes defined by the inner diameter portion 403 and the outer diameter portion 405, such that they extend toward each other into the annular channel 412. Particularly, the flanges 404 and 406 can be formed such that they extend in a direction substantially perpendicular to the planes defined by the inner diameter portion 403 and the outer diameter portion 405. The flanges 404 and 406 facilitate retaining an inner seal member 407 and an outer seal member 409 within the annular casing 401.

Moreover, the inner surfaces of the inner diameter portion 403 and outer diameter portion 405 include receiving ridges 421 and 422 respectively. The receiving ridges 421 and 422 generally extend along the circumference of the inner surfaces of the inner diameter portion 403 and outer diameter portion 405. The receiving ridges 421 and 422 facilitate placement and containment of the inner seal member 407 and the outer seal member 408.

Referring again to FIG. 4, the inner seal member 407 is generally adjacent to and extends along at least a portion of the receiving ridge 421 and the flange 404. According to a particular embodiment, the inner seal member 407 is in direct contact with of the receiving ridge 421, and the flange 404, and particularly extends along the entire surface of the receiving ridge 421 and the flange 404 through the circumference of the inner seal member 407.

The outer seal member 408 is generally adjacent to at least a portion of the receiving ridge 422 and the flange 406. In a particular embodiment, the outer seal member 408 is in direct contact with the receiving ridge 422, and the flange 406, and particularly extends along the entire surface of the receiving ridge 422 and the flange 406 through the circumference of the outer seal member 408. Notably, the inner seal member 407 and the outer seal member 408 extend at least partially into the opening 433 of the annular channel 412 toward each other, and particularly, the outer seal member 408 has a greater circumference than the inner seal member 407.

The inner seal member 407 and outer seal member 408 comprise seal angles 418 and 410 respectively. The seal angles are typically greater than about 90°, such as greater than about 110°, or greater than about 120°, and typically within a range of between about 100° and about 180°. In one particular embodiment, the seal angles 418 and 410 are within a range of between about 120° and about 160°. According to a particular embodiment, the seal angles 418 and 410 are the same.

Referring again to FIG. 4, face seal 400 illustrates an inner energizing member 413 and an outer energizing member 415. Generally, the inner energizing member 413 is adjacent to at least a portion of the inner seal member 407, the inner annular retainer 409, and the annular casing 401. According to a particular embodiment, the inner energizing member 413 is in direct contact with at least a portion of an inner surface and extends along at least a portion of the circumference of the inner seal member 407, the inner annular retainer 409, and the annular casing 401. Generally, the outer energizing member 415 is adjacent to at least a portion of the outer seal member 408, the outer annular retainer 411 and the annular casing 401. According to a particular embodiment, the outer energizing member 415 is in direct contact with at least a portion of an inner surface and extends along at least a portion of the circumference of the outer seal member 408, the outer annular retainer 411, and the annular casing 401.

The face seal 400 further includes an inner annular retainer 409 and an outer annular retainer 411. According to one embodiment, the inner annular retainer 409 is adjacent to at least a portion of the inner diameter portion 403 and the inner seal member 407. According to a particular embodiment, the inner annular retainer 409 is in direct contact with at least a portion of an inner surface of the inner diameter portion 403 and extends along at least a portion of the circumference of the inner diameter portion 403 and the inner seal member 407. Generally, the outer annular retainer 411 is adjacent to at least a portion of the outer diameter portion 405 and the outer seal member 408. According to a particular embodiment, the outer annular retainer 411 is in direct contact with at least a portion of the outer diameter portion 405 and extends along at least a portion of the circumference of the outer diameter portion 405 and the outer seal member 408. The inner annular retainer 409 and outer annular retainer 411 facilitate engagement and stabilization of the inner seal member 407 and the outer seal member 408 respectively. Notably, the outer annular retainer 411 has a circumference greater than the circumference of the inner annular retainer 409.

The base portion 402 of the annular casing 401 includes a raised portion 419. The raised portion 419 facilitates engagement of the inner energizing member 413 and outer energizing member 415. Generally, the raised portion 419 extends annularly through a circumference of the base portion 402. According to a particular embodiment, the raised portion 419 extends through the entire circumference of the base portion 402.

Additionally, the raised portion 419 generally has a width “Wᵣₚ” illustrated as the length of arrow 431 that is less than the width of the casing 401 “W_{c}” illustrated as the length of the arrow 432. Typically, the width of the raised portion 431 is not greater than about 90% of the total width of the casing 432. According to one embodiment, the width 431 of the raised portion 419 is not greater than about 80%, such as not greater than about 70% or even not greater than about 60% of the width 432 of the casing 401. Typically, in embodiments utilizing a raised portion 419, the width 431 of the raised portion is not less than about 20% of the width 432 of the casing 401.

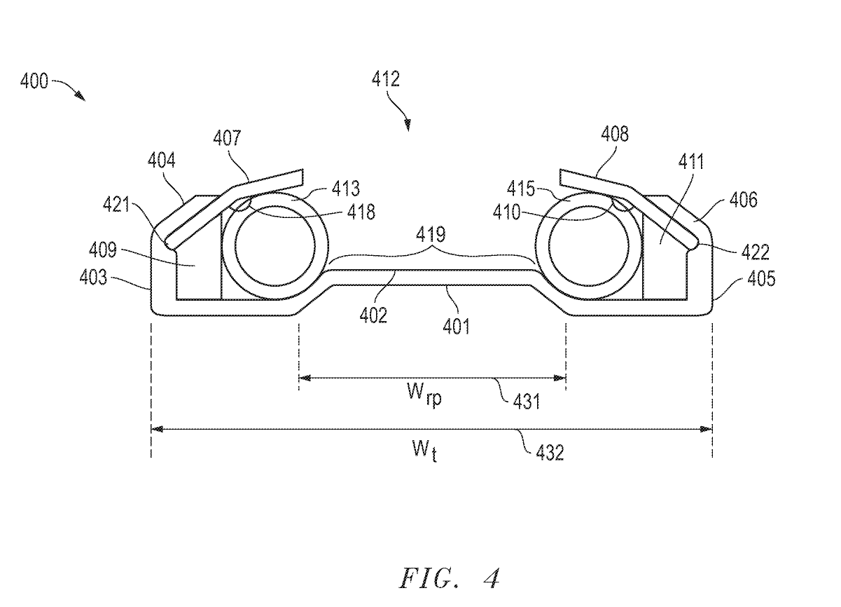

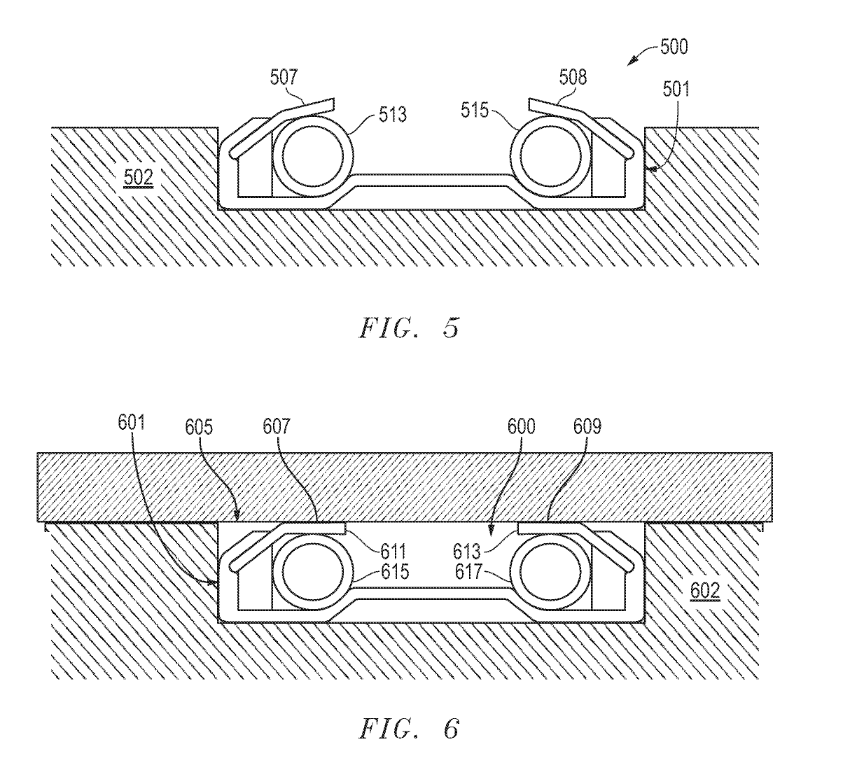

FIGS. 5 and 6 are provided in conjunction to further illustrate features of the present embodiments. FIG. 5 illustrates a cross-sectional view of a portion of a face seal 500 according to one embodiment. Notably, the face seal 500 is disposed within a channel 501 of a housing 502. The face seal 500 illustrates an inner seal member 507, an outer seal member 508, an inner energizing member 513, and an outer energizing member 515 in a relaxed state. Generally, the relaxed state of the face seal 500 is a state in which the inner seal member 507 and the outer seal member 508 are not engaged with a surface to form a seal.

Referring to FIG. 6, a cross-sectional view of a portion of a face seal 600 according to one embodiment is illustrated. The face seal 600 is disposed within a channel 601 of a housing 602, and is in an energized, or sealing state. The face seal 600 provides a seal against surface 605, and notably, face seal 600 provides dual sealing surfaces 607 and 609 corresponding to the inner seal member 611 and outer seal member 613 making contact with the surface 605. The face seal 600 is in the sealing state as the seal members 611 and 613 are deflected and substantially parallel to the surface 605 and the inner energizing member 615 and outer energizing member 617 are in a compressed state relative to the relaxed state illustrated in FIG. 5.

Generally, the sealing members 611 and 613 are deflected from the relaxed state to the sealed state by not less than about 2.0°. According to a particular embodiment, the deflection of the sealing members 611 and 613 between the relaxed state and the sealed state is not less than about 4.0°, such as not less than about 8.0°, such as not less than about 10°, or even not less than about 12°. Still, the degree of deflection is limited, and is generally not greater than about 90°.

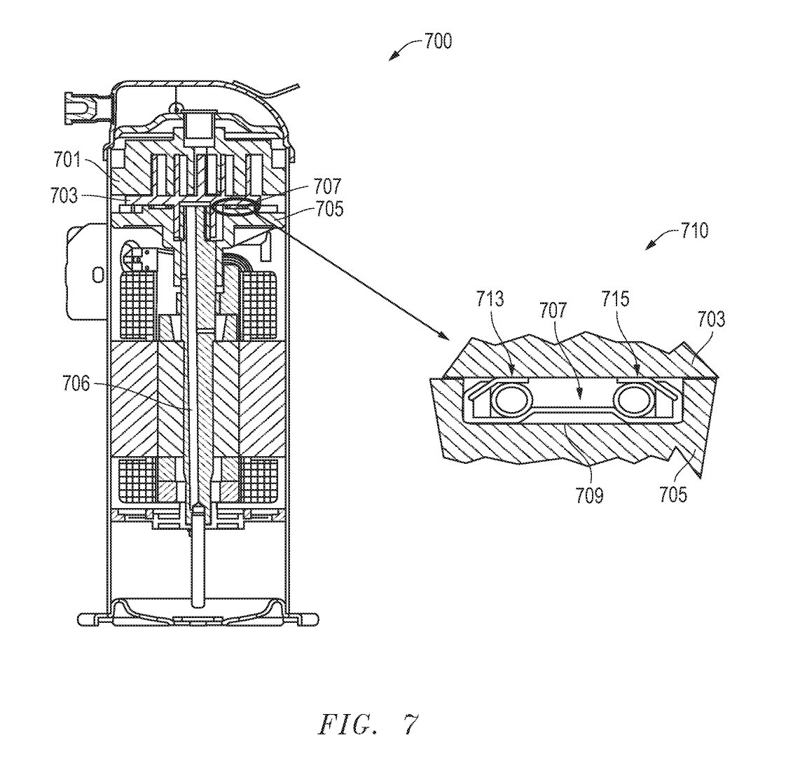

Referring to FIG. 7, a cross-sectional illustration of a scroll compressor 700 is illustrated. The scroll compressor 700 includes an upper scroll portion 701, a lower scroll portion 703, and a housing 705 which surrounds a rotating shaft 706. FIG. 7 further illustrates a face seal 707 disposed within a channel within the housing 705. The positioning of the face seal 707 within the housing 705 is provided in more detail in the magnified cross-sectional diagram 710. In reference to the diagram 710, the face seal 707 is disposed within a channel 709 of the housing 705. Moreover, the face seal 707 is illustrated in a sealing state providing a seal between the housing 705 and a bottom surface of the lower scroll portion 703. The face seal provides dual sealing surfaces 713 and 715 between the seal members and the bottom surface of the lower scroll portion.

According to a particular embodiment, the dual seal can withstand pressures greater than about 100 psi, such as greater than about 125 psi, or even, pressures greater than about 150 psi. Moreover, the components comprising face seal 707 are designed to withstand low temperatures and corrosive environments including chemicals, such as Freon.

The face seals provided herein and the method of forming such face seals, demonstrate a departure from the state of the art. The face seals incorporating the combination of elements provided in embodiments herein disclose a seal suitable for sealing two planar surfaces. Notably, the face seals described herein provide a combination of features such as a casing, inner and outer seals, resilient members, retaining members, and particularly integrated flanges and raised portions which facilitate an improved installation processes and a dual seal design having improved sealing performance. In the particular context of face seals used in compressors, the seals having the combination of elements disclosed herein provide superior sealing performance, installation and maintenance, lifetime, and resistance to chemical attack thereby improving the performance of a compressor.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A face seal comprising:
an annular casing having an annular portion, an inner diameter portion extending axially from the annular portion, an outer diameter portion extending axially from the annular portion, and a generally circular opening defined by the contour of an outer surface of the inner diameter portion;
an inner seal member disposed along an inner surface of the inner diameter portion; and
an outer seal member disposed along an inner surface of the outer diameter portion.

2. The face seal of claim 1, wherein the inner diameter portion has a height and the inner seal member has a height greater than the height of the inner diameter portion.

3. The face seal of claim 1, wherein the outer diameter portion has a height and the outer seal member has a height greater than the height of the outer diameter portion.

4. (canceled)

5. (canceled)

6. A face seal comprising:
an annular casing comprising a base portion, an inner diameter portion, and an outer diameter portion, wherein said inner diameter portion, outer diameter portion, and base portion define an annular channel, and wherein the inner diameter portion has a circumference less than the circumference of the outer diameter portion;
an inner seal member extending along at least a portion of the circumference of the inner diameter portion and extending at least partially into the channel; and
an outer seal member extending along at least a portion of the circumference of the outer diameter portion and extending at least partially into the channel.

7. The face seal of claim 1, further comprising an inner annular retainer adjacent to and extending along at least a portion of the circumference of the inner seal member.

8. (canceled)

9. The face seal of claim 1, further comprising an outer annular retainer adjacent to and extending along at least a portion of the circumference of the inner seal member.

10. (canceled)

11. The face seal of claim 1, wherein the seal comprises at least one energizing member.

12. (canceled)

13. (canceled)

14. The face seal of claim 11, wherein the seal comprises an inner energizing member adjacent to and extending along at least a portion of the circumference of the inner seal member.

15. The face seal of claim 11, wherein the seal comprises an outer energizing member adjacent to and extending along at least a portion of the circumference of the outer seal member.

16. The face seal of claim 1, wherein the inner seal member comprises an annular bend extending through a circumference of the inner seal member and defining a seal angle between a first seal portion and a second seal portion.

17. (canceled)

18. (canceled)

19. The face seal of claim 1, wherein the outer seal member comprises an annular bend extending through a circumference of the outer seal member and defining a seal angle between a first seal portion and a second seal portion.

20. (canceled)

21. (canceled)

22. The face seal of claim 1, wherein the inner seal member and the outer seal member extend towards each other into the channel.

23. (canceled)

24. (canceled)

25. (canceled)

26. The face seal of claim 1, wherein the inner seal member and the outer seal member comprise a polymer.

27. (canceled)

28. (canceled)

29. The face seal of claim 26, wherein the inner seal member and the outer seal member comprise a composite material.

30-39. (canceled)

40. The face seal of claim 1, wherein the inner seal member and the outer seal member define a dual seal.

41. The face seal of claim 40, wherein the dual seal withstands pressures greater than about 100 psi.

42. (canceled)

43. A method of forming a face seal comprising:
forming an annular casing comprising a base portion, an inner diameter portion, and an outer diameter portion, wherein said inner diameter portion, outer diameter portion, and base portion define an annular channel, and wherein the inner diameter portion has a circumference less than the circumference of the outer diameter portion;
forming an inner seal member having an annular shape;
forming an outer seal member having an annular shape;
combining the annular casing, inner seal member, and outer seal member to form a face seal, wherein the face seal comprises the inner seal member extending along at least a portion of the circumference of the inner diameter portion of the casing and extending at least partially into the channel, and the outer seal member extending along at least a portion of the circumference of the outer diameter portion of the casing and extending at least partially into the channel.

45-46. (canceled)

47. The method of claim 43, wherein forming the inner seal member and the outer seal member comprises cutting annular-shaped pieces of material from a larger strip of material.

48. The method of claim 47, wherein forming the inner seal member further comprises bending the inner seal member to form an annular bend through a circumference of the inner seal member.

49. The method of claim 47, wherein forming the outer seal member further comprises bending the outer seal member to form an annular bend through a circumference of the outer seal member.

50-57. (canceled)

58. The method of claim 43, wherein combining the inner seal member, outer seal member, and the casing comprises simultaneously pressing the inner seal member, outer seal member, and the casing together to form the face seal.

59-68. (canceled)
